(19) United States
(12) Patent Application Publication
(10) Pub. No.: US 2026/0366563 A1
(43) Pub. Date: Nov. 19, 2026

(54) BEARING COMPONENT AND BEARING

(71) Applicant: Wuxi Cummins Turbo Technologies Company Ltd., Jiangsu (CN)

(72) Inventor: Yi LU, Jiangsu (CN)

(21) Appl. No.: 19/136,420

(22) PCT Filed: Dec. 8, 2022
(86) PCT No.: PCT/CN2022/137603

§ 371 Date: Jun. 6, 2025

(51) Int. Cl. F16C 17/04; F01D 25/16

(52) U.S. Cl. CPC F16C 17/045; F01D 25/16; F05B 2240/52; F16C 2240/70; F16C 2360/24

(57) ABSTRACT

There is provided a component of a thrust bearing for a turbomachine, said component comprising a thrust surface including a plurality of thrust pads, wherein the component further includes a dam surrounding the plurality of thrust pads. Also provided is a thrust bearing including such a component as well as a turbomachine, vehicle, or stationary engine including such a component or thrust bearing.

### FIELD OF THE INVENTION

The present invention relates to a component of a thrust bearing for a turbomachine, a thrust bearing for a turbomachine, a turbomachine including such a component or thrust bearing, a vehicle including such a component, thrust bearing, or turbomachine, and a stationary engine including such a component, thrust bearing, or turbomachine. The present invention has particular, but not exclusive, application to turbochargers, pumps, turbines, compressors, and fuel cells.

### BACKGROUND OF THE INVENTION

Turbochargers are well-known devices for supplying air to the intake of an internal combustion engine at pressures above atmospheric pressure (boost pressure). A conventional turbocharger essentially comprises an exhaust gas driven turbine wheel mounted on a rotatable shaft within a turbine housing. Rotation of the turbine wheel rotates a compressor wheel mounted on the other end of the shaft within a compressor housing. The compressor wheel delivers compressed air to the inlet manifold of the engine, thereby increasing engine power. The turbocharger shaft is conventionally supported by journal and thrust bearings, including appropriate lubricating systems, located within a central bearing housing connected between the turbine and compressor wheel housing.

Turbochargers rotate at very high speeds, which often exceed 100,000 rpm and so it is necessary to use bearings to allow such high-speed operation. In operation, thrust bearings are used to carry the axial thrust exerted by rotating components and such thrust bearings utilise an oil film to reduce friction and to at least partially dampen vibrations.

U.S. Pat. No. 6,024,495 describes an axial sliding bearing including profiled annular surface of a lubricating gap arranged between the fixed bearing body and the rotating bearing collar is designed to rotate about or with the shaft. The annular surface has a plurality of radially arranged lubricating oil grooves each including a wedge surface connected in the circumferential direction. A catch surface is designed between each wedge surface and the lubricating oil groove adjacent to the latter. The lubricating oil grooves and the wedge surfaces are delimited radially outward by a sealing web. Under varying conditions, the height of the contact between the outer peripheral side and the slinger is flush with the oil slinger, but this can cause loss of lubrication under high thrust conditions, which can ultimately lead to failure.

In addition, it is desirable to increase the load capacity of bearings to increase range of operation conditions, and/or to allow for smaller bearings to be used to tolerate the same load capacities of existing bearings.

The present invention has been provided to address at least some of the deficiencies of the prior art.

### SUMMARY OF THE INVENTION

The present invention aims to provide new and useful components for thrust bearings, thrust bearings, turbomachines, vehicles and engines.

In general terms, the present invention provides a dam or wall surrounding a plurality of thrust pads provided on a component of a thrust bearing. The dam is an additional flat portion at the outer edge of the thrust land that has the same height as the flat thrust land. In this way, the dam may form a step between the dam and a taper land of the component. In operation, the dam serves as a barrier to the flow of lubricating oil across the component, and therefore a greater amount of lubricating oil is retained as a useful oil film.

As such, according to a first aspect of the present disclosure, there is provided a component of a thrust bearing for a turbomachine, said component comprising a thrust surface including a plurality of thrust pads, wherein the component further includes a dam surrounding the plurality of thrust pads.

The dam surrounding the plurality of thrust pads serves to retain lubricating oil at the thrust pads to a greater extent than if the dam were not present. This allows the component to accommodate a higher thrust load, thereby leading to improved performance. The dam surrounds the perimeter of a distal end of the component, thereby surrounding the plurality of thrust pads.

The dam may be provided at the outer diameter of the thrust pads. By providing the dam at the outer diameter of the thrust pads, this is the location where the lubricating oil would be slung by the rotational forces exerted upon the lubricating oil. By providing the dam at the outer diameter, the dam is located at the point of maximum centrifugal force for the lubricating oil.

The plurality of thrust pads may be separated by radially extending oil grooves.

Since it is necessary for the lubricating oil to flow in order to providing cooling, oil grooves may be provided to provide a path for the lubricating oil to flow through. The oil grooves may be angled such that their radial outer ends are disposed beneath the dam. In such an embodiment, the dam is continuous around the circumference of the component and includes one or more channels set apart from the top surface of the dam.

At least one of the plurality of thrust pads may include a flat land and a taper land. The flat land defines a plane denoting the top surface of the component. The taper land is tapered from the flat surface towards an adjacent oil groove, i.e. the taper land is angled away from the plane denoting the top surface of the component. As such, when viewed in a cross section a thrust pad is disposed between adjacent oil grooves and the flat land is adjacent a first oil groove, the flat land transitioning to a taper land in the direction of a second oil groove, with the taper land tapering down from the flat land to the second oil groove. In other terms, an oil groove is bordered on one side by a flat land of a thrust pad, the flat land partially defining the plane of top surface of the component, and the other side of the oil groove is bordered by a taper land of a thrust pad, in which the taper land is set away from the plane of the top surface of the component.

The provision of the dam surrounding the thrust pads provides a wall which retains the lubricating oil on the taper land to a greater extent than when there is no dam preventing the lubricating oil flow radially outwardly over the taper land.

The flat land may be flush with the dam. As such, the top of the dam is in the same plane as the flat lands on the plurality of thrust pads. In other words, the height of the dam may be the same as that of the flat lands. The integration of the outer dam increases the thrust capacity of the component.

A step may be formed between the dam and taper land. As such, the dam does not follow the taper land by tapering away from the plane of the top surface of the component, but remains at the same height as the flat land. Therefore, the height of the dam increases from zero at the beginning of the taper land, i.e. in the same plane as the flat land, and increases to a maximum height relative to the taper land at the portion of the taper land distal to the flat land.

The dam may be continuous. By providing a continuous dam, the lubricating oil is retained by the component more effectively. It will be appreciated that portions of the dam will be at the same height as the flat land, so by continuous it will be understood that the are no breaks in the dam at the plane of the top surface of the component. There may be gaps in the dam, such as oil grooves, spaced apart from the plane of the top surface.

The component may be unitary. By forming the component of a single piece, both manufacture and assembly are easier.

The component may be a part of a journal bearing. The component incudes two opposing ends, and the thrust surface as described in respect of the first aspect of the present disclosure may be provided at one or both of the opposing ends.

The dam has a dam width. The dam width is the radial thickness of the dam. The dam width may be from about 0.1 mm to about 3 mm. The dam width may be from about 0.1 mm to about 2 mm. Preferably, the dam thickness is from about 0.2 mm to about 1.6 mm, preferably from about 0.3 mm to about 0.7 mm, most preferably from about 0.4 mm to about 0.6 mm. The dam thickness may be around 0.1 mm, around 0.2 mm, around 0.3 mm, around 0.4 mm, around 0.5 mm, around 0.6 mm, around 0.7 mm, around 0.8 mm, around 0.9 mm, around 1.0 mm, around 1.1 mm, around 1.2 mm, around 1.3 mm, around 1.4 mm, around 1.5 mm, around 1.6 mm, around 1.7 mm, around 1.8 mm, around 1.9 mm, around 2.0 mm, around 2.1 mm, around 2.2 mm, around 2.3 mm, around 2.4 mm, around 2.5 mm, around 2.6 mm, around 2.7 mm, around 2.8 mm, around 2.9 mm, or around 3.0 mm. It will be appreciated that the dam thickness may be selected depending on the diameter of the component in order to achieve the desired performance. In embodiments, the dam thickness may be from about 0.2% to about 7% of the diameter of the thrust surface. The dam thickness may be about from about 0.4% to about 6%, from about 0.5% to about 5.5%, from about 0.6% to about 5%, from about 0.7% to about 4.5%, from about 0.8% to about 4%, from about 0.9% to about 3.5%, or from about 1.0% to about 3% of the diameter of the thrust surface. It will be appreciated that these figures may include tolerances of +/−20%, 15%, 10%, 5%, or 1% due to manufacturing limitations.

The component may be T-shaped. In other words, the component may include a flange at one or both ends that has a greater diameter than a body portion from which the flange extends. The flange allows for the thrust surface and/or the thrust pads to have a greater surface area, such that there is a higher thrust capacity. Having a T-shaped component may allow the component to withstand a large axial thrust force on account of the large surface area of the thrust surface and/or thrust pads, whilst managing the weight of the component by having a body portion which has a smaller diameter than the thrust surface.

According to a second aspect of the present disclosure, there is provided a thrust bearing including the component according to the first aspect of the present disclosure. The thrust bearing may be configured as a semi-floating thrust bearing. The thrust bearing may be a T-section bearing. By semi-floating, it will be understood that the component is restricted from free rotation. Compared to a fully-floating journal bearing, a semi-floating bearing does not rotate but still forms oil films at its inner and outer clearances. A degree of radial movement may be provided for damping, but free rotation is prevented. By allowing a degree of radial movement, the semi-floating bearing provides some damping, but is prevented from rotating freely as there needs to be a speed differential between the shaft associated with the component and the component itself in order to create hydrodynamic lift. Any suitable means for preventing rotation may be provided, for example a pin, a notch, or a non-circular cross-section, and the present disclosure is not necessarily particularly limited to any such means.

According to a third aspect of the present disclosure, there is provided a turbomachine including a component according to the first aspect of the present disclosure, or a thrust bearing according to the second aspect of the present disclosure.

The turbomachine may be one of a turbocharger, a pump, a turbine, a compressor, or a fuel cell. A fuel cell functions by reacting a fuel with an oxidant to generate electricity via redox reactions between the fuel and the oxidant. The fuel and/or the oxidant may be pressurised by a turbomachine including a component or bearing according to the present disclosure.

According to a fourth aspect of the present disclosure, there is provided a vehicle including a component according the first aspect of the present disclosure, a thrust bearing according to the second aspect of the present disclosure, or a turbomachine according to the third aspect of the present disclosure.

According to a fifth aspect of the present disclosure, there is provided a stationary engine including a component according the first aspect of the present disclosure, a thrust bearing according to the second aspect of the present disclosure, or a turbomachine according to the third aspect of the present disclosure.

It will be appreciated that features described in respect of one aspect of the present disclosure are equally applicable to any other aspect of the present disclosure, except where such features are mutually incompatible. As such, all features describing one aspect of the present invention equally apply to any other aspect of the present invention.

It will be appreciated that where appropriate any of the above aspects may incorporate one or more features of any of the other aspects.

### BRIEF DESCRIPTION OF THE FIGURES

Embodiments of the invention will now be described, by way of example only, with reference to the accompanying drawings, of which:

FIG. 1 depicts an exemplary journal bearing according to one aspect of the present disclosure;

FIG. 2a depicts a top surface of a component according to one aspect of the present disclosure;

FIG. 2b depicts a view of the component taken along line A-A;

FIG. 3a depicts a view of the flat land, taper land, and dam according to one aspect of the present disclosure:

FIG. 3b depicts a computer modelled image of the oil pressure on the thrust pads which include a dam;

FIG. 4a depicts a view of the flat land and taper land of a component which does not include a dam;

FIG. 4b depicts a computer modelled image of oil pressure on the thrust pads which do not include a dam;

FIG. 5a is a graph showing the load capacity versus dam width;

FIG. 5b is a graph showing the flow rate versus dam width;

FIG. 5c is a graph showing the power loss versus dam width; and

FIG. 6 depicts an embodiment of a component according to the present disclosure.

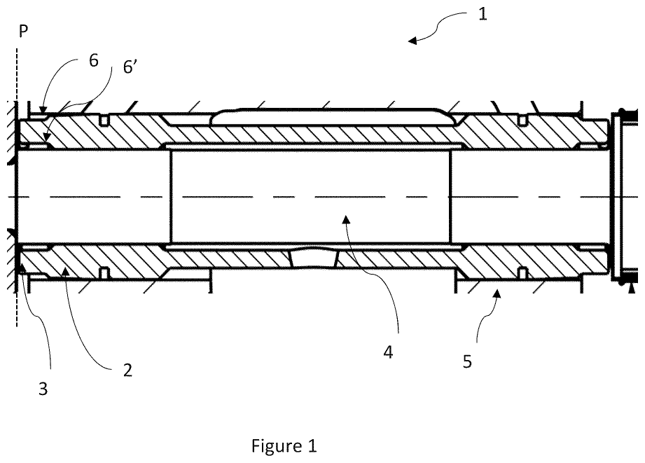

FIG. 1 depicts a journal bearing 1 according to the present disclosure. The bearing 1 includes a component 2 that includes a plurality of thrust pads 3. The component surrounds a shaft 4. In the depicted embodiment, the component 2 is a bearing and it is housed in a bearing housing 5. In the depicted embodiment, an inner step 6′ and an outer step 6 are provided next to the journal bearing thrust pads 3. The face or top surface of the component defines plane P (part of the dotted line depicting plane P is obscured by a solid black line, but it extends along the direction of the two exposed dotted lines). Plane P is located at the distal end of the component and the flat land 7 and dam 10 define the location of plane P.

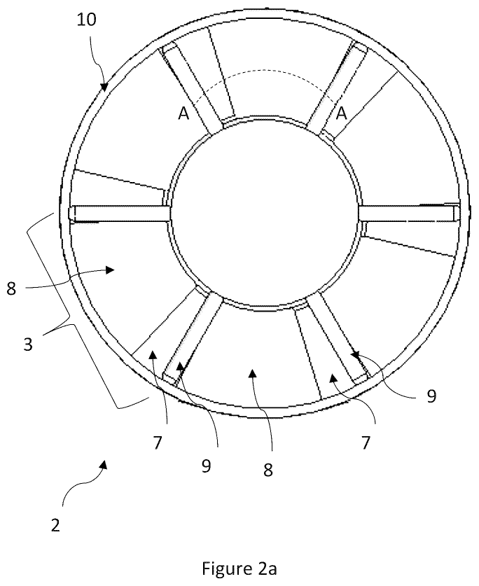

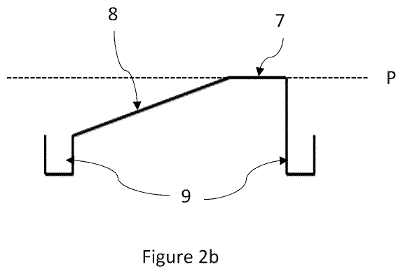

FIG. 2a depicts a top surface of a component 2 according to the present disclosure. Each thrust pad 3 includes a flat land 7 and a taper land 8. Adjacent thrust pads 3 are separated by oil grooves 9. Surrounding the perimeter of the top surface of the component 2 is a dam 10. As such, the dam 10 surrounds the plurality of thrust pads 3. The dam 10 is an additional flat portion at the outer edge of the thrust pads 3 that serves as a barrier to lubricating oil.

FIG. 2b depicts a view along line A-A shown in FIG. 2a. The thrust pad 3 includes flat land 7 and tapered land 8. Flat land 7 is in the plane P of the top surface of the component 2. Plane P also defines the height of the dam 10 (not shown in this figure). Tapered land 8 descends away from plane P towards an adjacent oil groove 9.

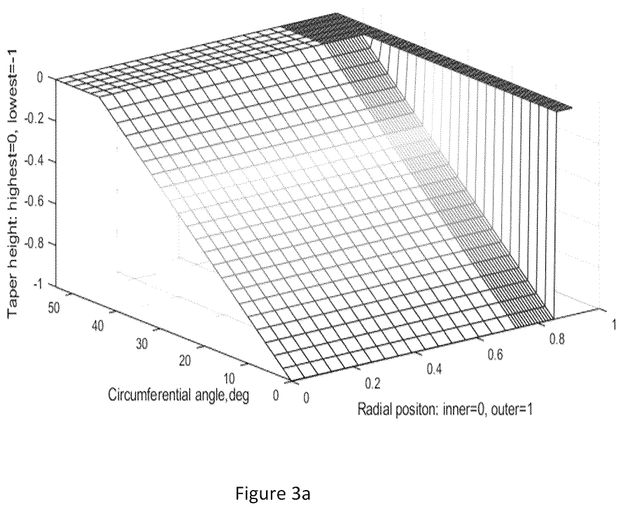

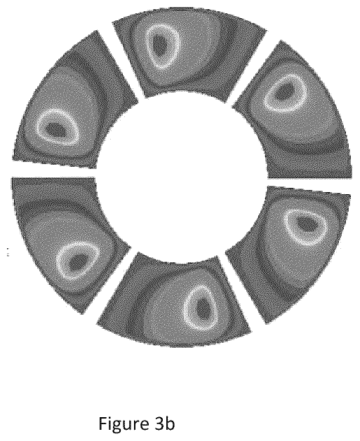

FIG. 3a depicts a computer modelled image of a section of a component 2 according to the present disclosure. The image depicts the flat land and the taper land portions of a thrust pad as well as the dam. As can be seen, the top of the dam and the flat land lie on the same plane.

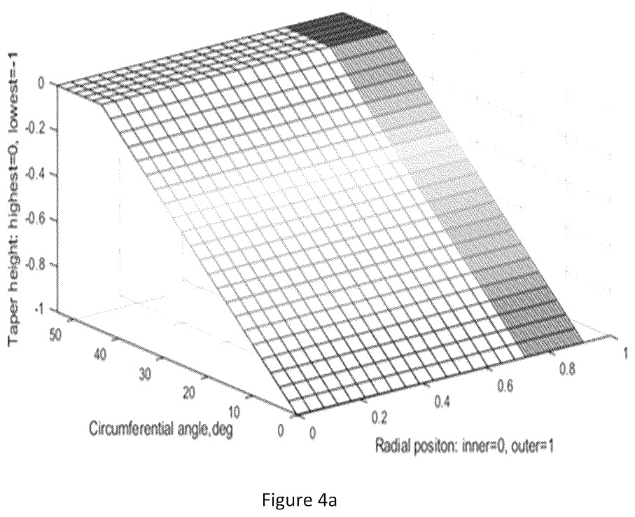

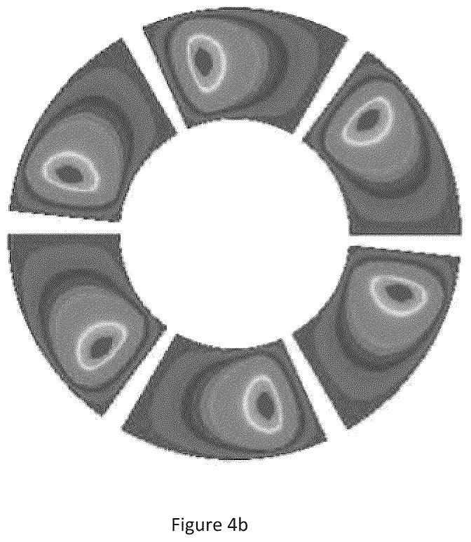

FIG. 3b depicts the predicted oil film pressure distribution across the thrust bearing pad area for components including a dam. As compared to FIG. 4b, which depicts a component not including a dam, the addition of the dam increases hydrodynamic film pressure towards the outer radius.

FIG. 4a depicts a prior art component which does not include a dam.

FIG. 4b depicts the predicted oil film pressure distribution across a thrust bearing pad area for a prior art component that does not include a dam.

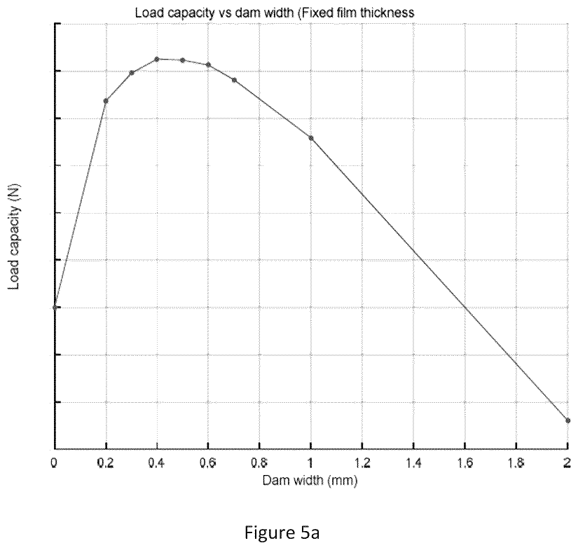

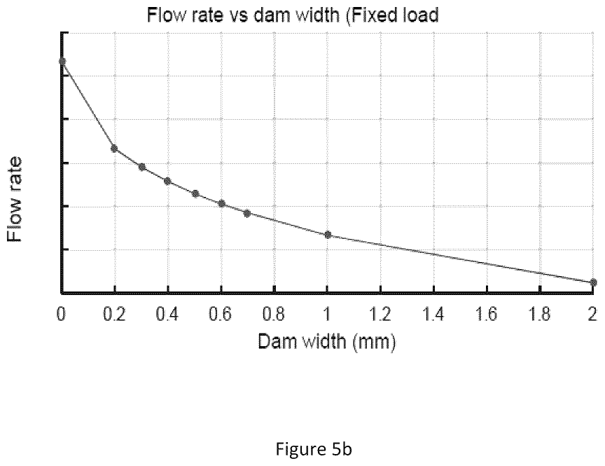

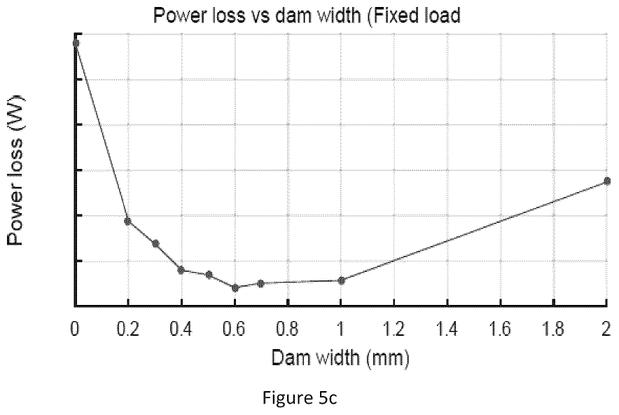

FIG. 5a is a graph showing the effect of dam width on load capacity for an exemplary bearing. With no dam, i.e. a dam width of 0 mm and at a fixed film thickness, the bearing has an initial load capacity. This value increases to a maximum with a dam width of 0.4 to 0.5 mm and then decreases with increasing dam width/thickness. Without wishing to be bound by scientific theory, it is believed that the dam retains lubricating oil in place allowing the maximum load capacity to be increased. With increasing dam width, the maximum load capacity reduces since the additional width of the dam reduces the volume of oil trapped between the taper land and the dam. It will be appreciated that the optimal thickness or width of the dam will depend on a number of factors, including the diameter of the component used in the bearing.

FIG. 5b is a graph showing the effect of dam width against flow rate at a fixed load. As can be seen, a wider dam reduces the flow rate. Again, without wishing to be bound by scientific theory, it is believed that this is due to the increase in the distance a portion of the oil needs to flow between the top face of the dam wall and the bearing housing. The increase in the length of the narrow passage between the top face of the dam wall and the bearing housing reduces the rate at which oil can flow.

FIG. 5c is a graph showing the effect of dam width versus power loss at a fixed load of an exemplary bearing. The power loss is minimised for dam widths of between around 0.4 mm and around 1.2 mm. As such, the presence of the dam serves to improve the efficiency of the component as well as increase its operating load capacity. Again, it will be appreciated that the effect will differ between bearings and so the dam width may be selected to provide the optimal reduction in power loss through routine experimentation.

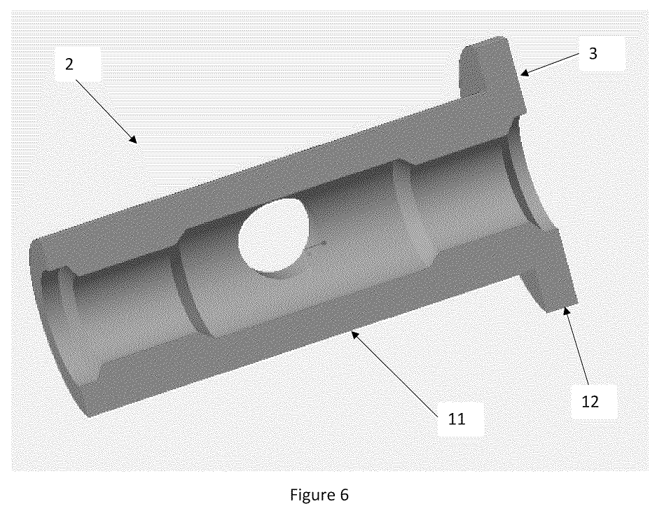

FIG. 6 depicts an embodiment of a component 2 in accordance with an embodiment of the present disclosure. The component 2 is T-shaped with a head portion 12 and a body portion 11. That is to say that the head portion 12 of the component 2 on which the thrust pads 3 are located has a larger diameter that the body potion 11. In other embodiments, the head portion 12 and the body portion 11 have substantially the same diameter.

The present disclosure provides bearings which show improved load capacities due to the presence of a dam. For example, the bearings can have an approximate 12% increase in load capacity by the additional of an outer dam wall having a thickness of around 0.4 to around 0.6 mm.

1. A component of a thrust bearing for a turbomachine, said component comprising a thrust surface including a plurality of thrust pads, wherein the component further includes a dam surrounding the plurality of thrust pads.

2. The component according to claim 1, wherein the dam is provided at the outer diameter of the thrust pads.

3. The component according to claim 1, wherein the plurality of thrust pads is separated by radially extending oil grooves.

4. The component according to claim 1, wherein at least one of the plurality of thrust pads includes a flat land and a taper land.

5. The component according to claim 4, wherein the flat land is flush with the dam.

6. The component according to claim 4, wherein there is a step formed between the dam and the taper land.

7. The component according to claim 1, wherein the dam is continuous.

8. The component according to claim 1, wherein the component is unitary.

9. The component according to claim 1, wherein the component is part of a journal bearing and includes two opposing ends, wherein a thrust surface according to claim 1 is provided on one or both opposing ends.

10. The component according to claim 1 wherein the dam has a dam width of between 0.1 mm and 2 mm, from 0.2 mm to 1.6 mm, from 0.3 mm to 0.7 mm, from 0.4 mm to 0.6 mm, 0.4 mm, 0.5 mm, or 0.6 mm.

11. The component according to claim 1, wherein the dam width is from 0.2% to 7% of the diameter of the thrust surface, from 0.4% to 6%, from 0.5% to 5.5%, from 0.6% to 5%, from 0.7% to 4.5%, from 0.8% to 4%, from 0.9% to 3.5%, or from 1.0% to 3% of the diameter of the thrust surface.

12. The component according to claim 1, wherein the component is T-shaped.

13. A thrust bearing including the component according to claim 1.

14. The thrust bearing according to claim 13, wherein the thrust bearing is configured as a semi-floating thrust bearing.

15. The thrust bearing according to claim 13, wherein the bearing is a T-section bearing.

16. A turbomachine including a component according to claim 1.

17. The turbomachine according to claim 16, wherein the turbomachine is one of a turbocharger, a pump, a turbine, a compressor, or a fuel cell.

18. A vehicle including a component according to claim 1.

19. A stationary engine including a component according to claim 1.
